(19) United States
(12) Patent Application Publication
(10) Pub. No.: US 2005/0127913 A1
(43) Pub. Date: Jun. 16, 2005

(54) LC COIL

(75) Inventor: Seth David Berger, Watertown, MA (US)

Correspondence Address: Seth David Berger, 36 Lawrence St, Watertown, MA, 02472, US

(73) Assignee: Seth David Berger, Watertown, MA (US)

(21) Appl. No.: 10/707,434

(22) Filed: Dec. 12, 2003

(51) Int. Cl. G01V 3/00

(52) U.S. Cl. 324/318

(57) ABSTRACT

A coil for a magnetic resonance imaging machine includes two adjacent regions carrying currents that differ at the interface.

### BACKGROUND

In magnetic resonance imaging, the rate of data acquisition is limited by how rapidly fields can be changed within the field of view. However, bounds are generally placed on how rapidly fields can be changed within an often larger region, such as a patient. With reduced fields outside the field of view, data acquisition can be acclerated.

### SUMMARY

This invention provides a coil for a magnetic resonance imaging machine with two adjacent regions carrying different currents at the interface. Currents in the two regions at the interface can be in opposite directions.

The interface separating the two adjacent regions can be planar and the regions can be mirror images of each other across the interface. Current in one region and the opposite of current in the other region can be mirror images of each other across the planar interface. The current density, or volume current density integrated over the thickness of the coil, can be constant in each region.

The two adjacent regions of the coil can pass directly under and conform to a support surface, which can be flat. The cross-section of the coil can contain an arc of a circle.

### BRIEF DESCRIPTION OF THE FIGURES

FIG. 1 shows the first embodiment of the coil, side view (FIG. 1A) and axial view (FIG. 1B).

FIG. 2 shows the second embodiment of the coil, side view (FIG. 2A) and axial view (FIG. 2B).

### DETAILED DESCRIPTION

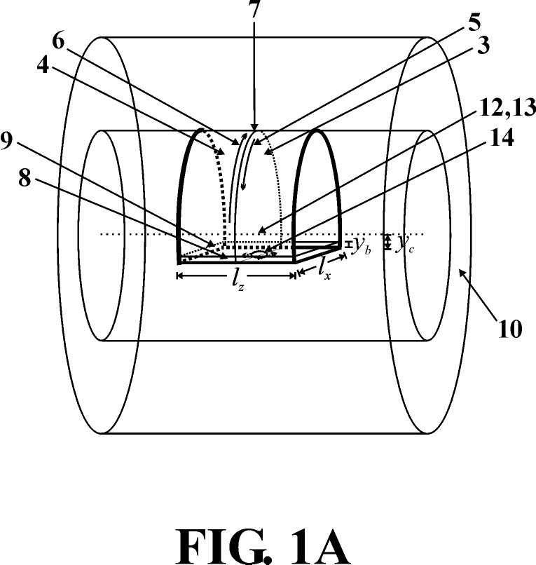

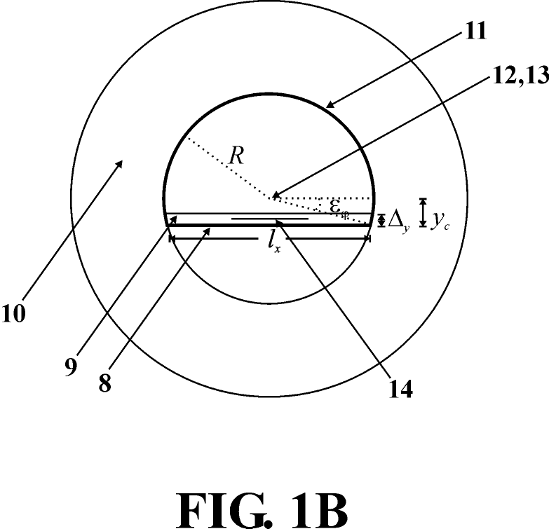

FIG. 1 shows a coil within a magnetic resonance imaging machine 10. The coil has region 3 carrying current 5 and adjacent region 4 carrying current 6. Currents 5 and 6 differ at the interface 7 between the regions 3 and 4. The coil has a flat lower part 8 passing under a support surface 9 of the magnetic resonance imaging machine 10 and a partial cylindrical upper part 11 with axis 12.

Throughout this specification, the term “LC coil” refers to this invention, the terms “axial”, “z direction”, and “along z ” refer to the direction of a specified axis of the LC coil, and “LC_{z} coil” refers to an LC coil designed to produce an axial gradient of an axial magnetic field. Terms “LCₓ coil” and “LC_{y} coil” refer to LC coils designed to produce gradiy ents of an axial magnetic field orthogonal to the axis. The term “scanner” refers to a magnetic resonance imaging machine.

### 1 First Embodiment

The first embodiment (FIG. 1) of an LC_{z} coil has region 3 carrying current 5 and adjacent region 4 carrying current 6. Currents 5 and 6 differ at the interface 7 between the regions 3 and 4. The first embodiment has a flat lower part S₁ 8 passing a distance Δ_{y} under a flat support surface 9 of a scanner 10 and upper part S₂ 11 a partial cylinder of radius R , angle (1+2ε_{φ})π, ε_{φ}∈[0, ½], and axis 12 coinciding with the scanner axis 13. The axis 12 is also called the coil axis. The length of the first embodiment along its axis 12 is l_{z} and the dimension of S₁ 8 are lₓ×l_{z}, with l_{x≦2}. The distance between S₁ 8 and the axis 12 is y_{c} . A surface detection coil 14 is located between S₁ 8 and the support surface 9.

1.1 Definition of Coordinates

Define rectangular coordinates (x, y, z) with x parallel the support surface 9, y perpendicular to the support surface 9, and z along the coil axis 12. The flat section S₁ 8 is in the plane y=−y_{c} and is parallel to the support surface 9 in the plane y=−y_{c}+Δ_{y}. The plane x=0 perpendicular to the support surface 9 contains the coil axis 12 given by the line x=0 and y=0. Centers of fields of view are arranged to lie within the plane z=0.

Cylindrical coordinates (r, φ, z) are related to coordinates (x, y, z) by the transformation
x=r cos φ (1a)
y=r sin φ (1b)
The inverse transformation is

$$\begin{matrix}r = \sqrt{{x}^{2} + {y}^{2}} & ( 2 a ) \\ φ = {cos}^{- 1} \frac{x}{r} = {sin}^{- 1} \frac{y}{r} & ( 2 b )\end{matrix}$$

The partial cylindrical section S₂ 11 is at r=R and covers the angular range
φ∈I_{φ}=[−ε_{φ}π, (1ε_{φ})π] (3)

The coil dimensions
lₓ=2R cos(ε_{φ}π) (4a)
and
y_{c}R sin (ε_{φ}π (4b)
1.2 Current Density

The coil carries a current density

$$\vec{J} ( \vec{r} ) = \{ \begin{matrix}J ( z ) \hat{x} , & \vec{r} ∈ {S}_{1} \\ J ( z ) \hat{φ} , & \vec{r} ∈ {S}_{2}\end{matrix} \qquad ( 5 )$$

where J(z) is the current density profile and
\vec{r}=(x, y, z) (6)
1.3 Field

Using the Biot-Savart law, the total field

$$\begin{matrix}B ( x , y , z ) = {\int }_{- {l}_{z} / 2}^{{l}_{z} / 2} ⅆ {z}^{′} J ( {z}^{′} ) g ( x , y , z - {z}^{′} ) \\ with & ( 7 ) \\ \begin{matrix}g ( x , y , z ) = \frac{{μ}_{0} ( y + {y}_{c} )}{4 π} {\int }_{- {l}_{x} / 2}^{{l}_{x} / 2} ⅆ {x}^{′} \frac{1}{{[ {( x - {x}^{′} )}^{2} + {( y + {y}_{c} )}^{2} + {z}^{2} ]}^{3 / 2}} + \\ \frac{{μ}_{0} R}{4 π} {\int }_{{I}_{φ}} ⅆ {φ}^{′} \frac{R - r cos ( φ - {φ}^{′} )}{{[ {R}^{2} + {r}^{2} - 2 Rr cos ( φ - {φ}^{′} ) + {z}^{2} ]}^{3 / 2}}\end{matrix} & ( 8 )\end{matrix}$$

Under conditions

$$\begin{matrix}\vert x \vert , \vert y + {y}_{c} \vert << {l}_{x} / 2 & ( 9 a ) \\ \vert y + {y}_{c} \vert << {l}_{z} / 2 & ( 9 b ) \\ \sqrt{{x}^{2} + {y}^{2}} << R & ( 9 c )\end{matrix}$$

the function

$$\begin{matrix}g ( x , y , z ) \approx \frac{{μ}_{0}}{2 π} \frac{y + {y}_{c}}{2 {π ( y + {y}_{c} )}^{2} + {z}^{2}} + \\ \frac{{μ}_{0}}{4 π} \frac{{R}^{2}}{{[ {R}^{2} + {z}^{2} ]}^{3 / 2}} [ ( 1 + 2 {ɛ}_{φ} ) π + \\ \frac{{l}_{x} y \sqrt{{x}^{2} + {y}^{2}}}{{R}^{3}} ( \frac{3 {R}^{2}}{{R}^{2} + {z}^{2}} - 1 ) ]\end{matrix} \qquad ( 10 )$$

If the projection of the field of view onto the x−y plane is a rectangle Lₓ×L_{y} centered about (x₀, y₀) under conditions
Lₓ/2, |x₀|<<R (11a)
L_{y}/2, |y₀|<<R, l_{z}/2 (11b)
and
y₀≦−y_{c}+Δ_{y}+L_{y}/2 (11c)
and the coil parameter
y_{c}≦≦R, l_{z}/2 (12)
then conditions (9) are satisfied within the field of view.
1.4 Field with (14)

Define the function sgn by

$$sgn z = \{ \begin{matrix}1 , z \geq 0 \\ - 1 , x < 0\end{matrix} \qquad ( 13 )$$

Under conditions (9) with
J(z)=J₀sgn z (14)
the field

$$\begin{matrix}\begin{matrix}B ( x , y , z ) \approx b ( x , y , z ) - \frac{1}{2} [ b ( x , y , z - {l}_{z} / 2 ) + \\ b ( x , y , z + {l}_{z} / 2 ) ]\end{matrix} \\ with & ( 15 a ) \\ \begin{matrix}b ( x , y , z ) = \frac{{μ}_{0} {J}_{0}}{π} {Tan}^{- 1} \frac{z}{y + {y}_{c}} + \\ \frac{{μ}_{0} {J}_{0} z}{2 \sqrt{{R}^{2} + {z}^{2}}} [ ( 1 + 2 {ɛ}_{φ} ) + \\ \frac{{l}_{x} y \sqrt{{x}^{2} + {y}^{2}}}{π R} ( \frac{1}{{R}^{2}} + \frac{1}{{R}^{2} + {z}^{2}} ) ]\end{matrix} & ( 15 b )\end{matrix}$$

using (2a).

Under conditions (9) and
|z|≦≦l_{z}/2, R (16)
with (14), the field

$$B ( x , y , z ) \approx \frac{{μ}_{0} {J}_{0}}{π} {Tan}^{- 1} \frac{z}{y + {y}_{c}} \qquad ( 17 )$$

the gradient

$$\begin{matrix}{{G}_{z} = \frac{\partial B}{\partial z} \vert}_{( x , y , z ) = ( {x}_{0} , {y}_{0} , 0 )} & ( 18 a ) \\ \approx \frac{{μ}_{0} {J}_{0}}{π ( {y}_{0} + {y}_{c} )} & ( 18 b )\end{matrix}$$

### 2 Second Embodiment

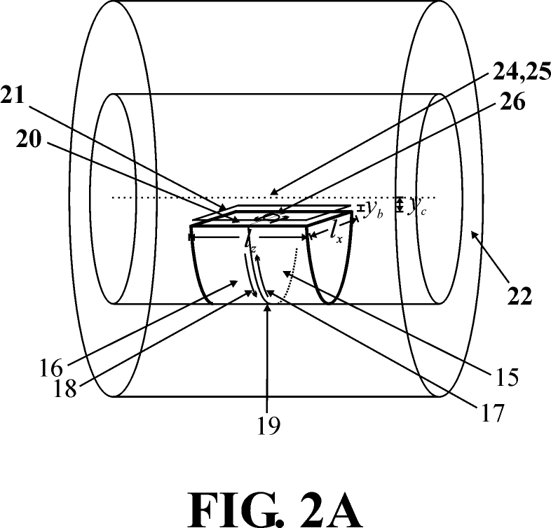

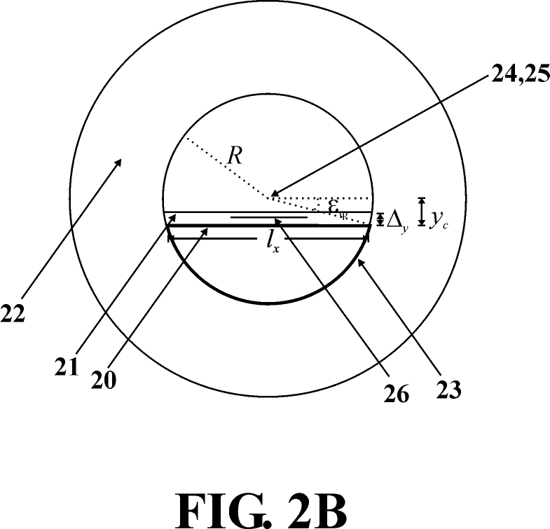

The second embodiment (FIG. 2) of an LC_{z} coil has region carrying current 17 and adjacent region 16 carrying current 18. Currents 17 and 18 differ at the interface 19 between the regions 15 and 16. The second embodiment has a flat upper part S₁ 20 passing a distance Δ_{y} under a flat support surface 21 of a scanner 22 and lower part S₂ 23 a partial cylinder of radius R , angle (1+2ε_{φ})π, ε_{φ}∈[0, ½], and axis 24 coinciding with the scanner axis 25. The axis 25 is also called the coil axis. The length of the second embodiment along its axis 24 is l_{z} and the dimension of S₁ 20 are lₓ×l_{z}, with lₓ≦2R . The distance between S₁ 20 and the axis 24 is y_{c}. A surface detection coil 26 is located between S₁ 20 and the support surface 21

2.1 Definition of Coordinates

Define rectangular coordinates (x, y, z) with x parallel the support surface 21, y perpendicular to the support surface 21, and z along the coil axis 24. The flat section S₁ 20 is in the plane y=−y_{c} and is parallel to the support surface 21 in the plane y=−y_{c}+Δ_{y}. The plane x=0 perpendicular to the support surface 21 contains the coil axis 24 given by the line x=0 and y=0. Centers of fields of view are arranged to lie within the plane z=0.

Cylindrical coordinates (r, φ, z) are related to coordinates (x, y, z) by the transformation (1). The inverse transformation is (2). The partial cylindrical section S₂ 23 is at r=R and covers the angular range
φ∈I_{φ}=[−(1−ε_{φ})π, −ε_{φ}π] (19)

The coil dimensions lₓ and y_{c} are given by (4a) and (4b).

2.2 Current Density

The coil carries a current density

$$\vec{J} ( \vec{r} ) = \{ \begin{matrix}J ( z ) \hat{x} , & \vec{r} ∈ {S}_{1} \\ - J ( z ) \hat{φ} , & \vec{r} ∈ {S}_{2}\end{matrix} \qquad ( 20 )$$

where J(z) is the current density profile.
2.3 Field

The first and second embodiments have different partial cylindrical sections S₂ 11 and S₂ 23: current densities (5) and (20) for \vec{r}∈S₂ are carried in complementary angular ranges (3) and (19). Expressions for the field produced by the second embodiment can be obtained by modifying the expressions of Sec. (1.3).

The field

$$\begin{matrix}B ( x , y , z ) = {\int }_{- {l}_{z} / 2}^{{l}_{z} / 2} ⅆ {z}^{′} J ( {z}^{′} ) g ( x , y , z - {z}^{′} ) & ( 21 ) \\ with & \\ \begin{matrix}g ( x , y , z ) = \frac{{μ}_{0} ( y + {y}_{c} )}{4 π} {\int }_{- {l}_{x} / 2}^{{l}_{x} / 2} ⅆ {x}^{′} \\ \frac{1}{{[ {( x - {x}^{′} )}^{′2} + {( y + {y}_{c} )}^{2} + {z}^{2} ]}^{3 / 2}} - \\ \frac{{μ}_{0} R}{4 π} {\int }_{{I}_{φ}} ⅆ {φ}^{′} \frac{R - r cos ( φ - {φ}^{′} )}{{[ {R}^{2} + {r}^{2} - 2 Rr cos ( φ - {φ}^{′} ) + {z}^{2} ]}^{3 / 2}}\end{matrix} & ( 22 )\end{matrix}$$

r can be expressed in terms of x and y using (2a). Under conditions (9),

$$\begin{matrix}g ( x , y , z ) \approx \frac{{μ}_{0}}{2 π} \frac{y + {y}_{c}}{{( y + {y}_{c} )}^{2} + {z}^{2}} - \\ \frac{{μ}_{0}}{4 π} \frac{{R}^{2}}{{[ {R}^{2} + {z}^{2} ]}^{3 / 2}} [ ( 1 - 2 {ɛ}_{φ} ) π + \\ \frac{{l}_{x} y \sqrt{{x}^{2} + {y}^{2}}}{{R}^{3}} ( \frac{3 {R}^{2}}{{R}^{2} + {z}^{2}} - 1 ) ]\end{matrix} \qquad ( 23 )$$

If the projection of the field of view onto the x−y plane is a rectangle Lₓ×L_{y} centered about (x₀, y₀) under conditions (11) and the coil parameter y_{c} satisfies (12), then conditions (9) are satisfied within the field of view.

2.4 Field with (14)

Expressions for the field and gradient produced by the second embodiment can be obtained by modifying the expressions of Sec. (1.4).

Under conditions (9) with (14), the field

$$\begin{matrix}\begin{matrix}B ( x , y , z ) \approx b ( x , y , z ) - \frac{1}{2} [ b ( x , y , z ) - {l}_{z} / 2 ) + \\ b ( x , y , z + {l}_{z} / 2 ) ]\end{matrix} \\ with & ( 24 a ) \\ \begin{matrix}b ( x , y , z ) = \frac{{μ}_{0} {J}_{0}}{π} {Tan}^{- 1} \frac{z}{y + {y}_{c}} - \\ \frac{{μ}_{0} {J}_{0} z}{2 \sqrt{{R}^{2} + {z}^{2}}} [ ( 1 - 2 {ɛ}_{φ} ) + \\ \frac{{l}_{x} y \sqrt{{x}^{2} + {y}^{2}}}{π R} ( \frac{1}{{R}^{2}} + \frac{1}{{R}^{2} + {z}^{2}} ) ]\end{matrix} & ( 24 b )\end{matrix}$$

Under conditions (9) and (16) with (14), the field B is (17) and the gradient G_{z} is (18)

3 MRI Using an LC Coil

3.1 Field Profiles

The three types of LC coil are LCₓ, LC_{y}, and LC_{z}. An LCₓ coil produces an LC_{X} field
b(\vec{r}, ι)=Gₓ(ι)\tilde{x}(\vec{r}) (25a)
with gradient

$${G}_{x} = \frac{\partial B}{\partial x} \qquad ( 25 b )$$

An LC_{y} coil produces an LC_{y} field
B(\vec{r}, t)=G_{y}(t)\tilde{y}(\vec{r}) (26a)
with gradient

$${G}_{y} = \frac{\partial B}{\partial y} \qquad ( 26 b )$$

An LC_{z} coil produces an LC_{z} field
B(\vec{r}, ι)=G_{z}(ι)\tilde{z}(\vec{r}) (27
with gradient

$${G}_{z} = \frac{\partial B}{\partial z} \qquad ( 27 b )$$

The gradients are evaluated at the center of the field of view.

Magenetic resonance imaging with an LC_{z} coil requires that \tilde{z}(\vec{r}) satisfy
\tilde{z}=0 at the center of the field of view (28a)
θ\tilde{z}/θz=1 at the center of the field of view (28b)
θ\tilde{z}/θz≧0 within the field of view (28c)
and
\tilde{z} attains values for fixed x and y within the field of view that are unique within the region of sensitivity of the detection coil (28d)
Magnetic resonance imaging with an LCₓ coil requires that \tilde{x}(\vec{r}) satisfy (28) with x [symbol] z and \tilde{x} [symbol] \tilde{z}. Magnetic resonance imaging with an LC_{y} coil requires that \tilde{y}(\vec{r}) satisfy (28) with y [symbol] z and \tilde{y} [symbol] \tilde{z}.

The center of a field of view refers to the center of an image in field coordinates. For example, if fields linear in x and y are used with an LC_{z} field linear in \tilde{z}, the field of view is a rectangular box in field coordinates (x, y, \tilde{z}) and the center of the field of view refers to the center of the box.

3.2 Imaging Parameters

This section assumes the use of an LC_{z} field together with fields linear in x and y . Similar equations hold for other combinations of LC and linear fields.

3.2.1 Non-Oblique Imaging Parameters

In field coordinates (x, y, \tilde{z}) , the field of view is a box Lₓ×L_{y}×\tilde{L}_{z} centered about
(x, y, \tilde{z})=(x₀, y₀, 0) [symbol] (x, y, z)=(x₀, y₀, z₀) (29)
With choices for pixel numbers Nₓ, N_{y}, N_{z}, and pixel sizes Δx, Δy, Δz , the imaging parameters are

$$\begin{matrix}{L}_{x} = {N}_{x} Δ x & ( 30 a ) \\ {L}_{y} = {N}_{y} Δ y & ( 30 b ) \\ {\tilde{L}}_{z} = {N}_{z} Δ z & ( 30 c ) \\ {k}_{x} = {n}_{x} Δ {k}_{x} & ( 31 a ) \\ {k}_{y} = {n}_{y} Δ {k}_{y} & ( 31 b ) \\ {k}_{z} = {n}_{z} Δ {k}_{z} & ( 31 c ) \\ {n}_{x} ∈ \{ - {N}_{x} / 2 , … , {N}_{x} / 2 - 1 \} & ( 32 a ) \\ {n}_{y} ∈ \{ - {N}_{y} / 2 , … , {N}_{y} / 2 - 1 \} & ( 32 b ) \\ {n}_{z} ∈ \{ - {N}_{z} / 2 , … , {N}_{z} / 2 - 1 \} & ( 32 c ) \\ Δ {k}_{x} = \frac{2 π}{{L}_{x}} & ( 33 a ) \\ Δ {k}_{y} = \frac{2 π}{{L}_{y}} & ( 33 b ) \\ Δ {k}_{z} = \frac{2 π}{{\tilde{L}}_{z}} & ( 33 c )\end{matrix}$$

Fourier reconstruction yields an image on a grid in field coordinates:
(x, y, \tilde{z})=(nₓΔx+x₀, n_{y}Δy+y₀, n_{z}Δz) (34)
The image can be scaled to coordinates (x, y, z) using the 1-to-1 mapping
(x, y, z) [symbol] (x, y, \tilde{z}) within F∩D (35)
The resolutions in coordinates (x, y, z) are accurately given by
(Δx, Δy, Δz)J′=(Δx, Δy, Δz(θ\tilde{z}/θz)⁻¹) (36)
where Jacobian

$${J}^{′} = \frac{\partial ( x , y , z )}{\partial ( x , y , \tilde{z} )} = [ \begin{matrix}1 & 0 & 0 \\ 0 & 1 & 0 \\ 0 & 0 & {( \partial \tilde{z} / \partial z )}^{- 1}\end{matrix} ] \qquad ( 37 )$$

using the relation
θz/θ\tilde{z}=(θ\tilde{z}/θz)⁻¹ (38)
which follows from the fact that both θz/θ\tilde{z}and θ\tilde{z}/θz are taken at constant x and y . At the center of the field of view (29), the Jacobian J′is the identity matrix and the resolutions are Δx, Δy, Δz .
3.2.2 Double-Oblique Imaging Parameters

Coordinates (x′, y′, z′) and field coordinates (\tilde{x}′, \tilde{y}′, \tilde{z}′) are obtained from coordinates (x, y, z) and field coordinates (x, y, \tilde{z}) by a rotation by θ₁ about z and a rotation by θ₂ about x :
(x′, y′, z′)=(x, y, z)R [symbol] (x, y, z)=(x′, y′, z′)R⁻¹ (39)
and
(\tilde{x}′, \tilde{y}′, \tilde{z}′)=(x, y, \tilde{z})R [symbol] (x, y, \tilde{z})=(\tilde{x}′, \tilde{y}′, \tilde{z}′)R⁻¹ (40)
where the rotation matrix

$$R = [ \begin{matrix}cos {θ}_{1} & - sin {θ}_{1} & 0 \\ sin {θ}_{1} cos {θ}_{2} & cos {θ}_{1} cos {θ}_{2} & - sin {θ}_{2} \\ sin {θ}_{1} sin {θ}_{2} & cos {θ}_{1} sin {θ}_{2} & cos {θ}_{2}\end{matrix} ] \qquad ( 41 )$$

and inverse matrix

$${R}^{- 1} = [ \begin{matrix}cos {θ}_{1} & sin {θ}_{1} cos {θ}_{2} & sin {θ}_{1} sin {θ}_{2} \\ - sin {θ}_{1} & cos {θ}_{1} cos {θ}_{2} & cos {θ}_{1} sin {θ}_{2} \\ 0 & - sin {θ}_{2} & cos {θ}_{2}\end{matrix} ] \qquad ( 42 )$$

Consider combining fields linear in x , y , and \tilde{z} according to (40) to create fields linear in \tilde{x}′, \tilde{y}′, and \tilde{z}′. In field coordinates (\tilde{x}′, \tilde{y}′, \tilde{z}′) , the field of view is a box \tilde{L}_{x′}×_{y′}×\tilde{L}_{z′} centered about

$$\begin{matrix}( x , y , \tilde{z} ) = ( {x}_{0} , {y}_{0} , 0 ) & ⇔ & ( {\tilde{x}}^{′} , {\tilde{y}}^{′} , {\tilde{z}}^{′} ) = ( {\tilde{x}}_{0}^{′} , {\tilde{y}}_{0}^{′} , {\tilde{z}}_{0}^{′} ) \\ & ⇔ & ( {x}^{′} , {y}^{′} , {z}^{′} ) = ( {x}_{0}^{′} , {y}_{0}^{′} , {z}_{0}^{′} )\end{matrix} \qquad ( 43 )$$

With choices for pixel numbers N_{x′}, N_{y′}, N_{z′}, and pixel numbers Δx′, Δy′, Δz′, the imaging parameters are
\tilde{L}_{x′}=N_{x′}Δx′ (44a)
\tilde{L}_{y′}=N_{y′}Δy′ (44b)
\tilde{l}_{z′}=N_{z′}Δz′ (44c)

$$\begin{matrix}{k}_{{x}^{′}} = {n}_{{x}^{′}} Δ {k}_{{x}^{′}} & ( 45 a ) \\ {k}_{{y}^{′}} = {n}_{{y}^{′}} Δ {k}_{{y}^{′}} & ( 45 b ) \\ {k}_{{z}^{′}} = {n}_{{z}^{′}} Δ {k}_{{z}^{′}} & ( 45 c ) \\ {n}_{{x}^{′}} ∈ \{ - {N}_{{x}^{′}} / 2 , … , {N}_{{x}^{′}} / 2 - 1 \} & ( 46 a ) \\ {n}_{{y}^{′}} ∈ \{ - {N}_{{y}^{′}} / 2 , … , {N}_{{y}^{′}} / 2 - 1 \} & ( 46 b ) \\ {n}_{{z}^{′}} ∈ \{ - {N}_{{z}^{′}} / 2 , … , {N}_{{z}^{′}} / 2 - 1 \} & ( 46 c ) \\ Δ {k}_{{x}^{′}} = \frac{2 π}{{\tilde{L}}_{{x}^{′}}} & ( 47 a ) \\ Δ {k}_{{y}^{′}} = \frac{2 π}{{\tilde{L}}_{{y}^{′}}} & ( 47 b ) \\ Δ {k}_{{z}^{′}} = \frac{2 π}{{\tilde{L}}_{{z}^{′}}} & ( 47 c )\end{matrix}$$

Fourier reconstruction yields an image on a grid:
(\tilde{x}′, \tilde{y}′, \tilde{z})=(n_{x′}Δx′+\tilde{x}′₀, n_{y′}Δy′+\tilde{y}₀, n_{z′}Δz′+\tilde{z}₀) (48)
The image can be scaled to coordinates (x′, y′, z′) using the 1-1 mapping (35) and the transformations (39) and (40):
(\tilde{x}′, \tilde{y}′, \tilde{z}′)→(x, y, \tilde{z})→(x, y, z)→(x′, y′, z′) (49)
The resolutions in coordinates (x′, y′, z′) are accurately given by
(Δx′, Δy′, Δz′)J′ (50)
where Jacobian
\tilde{J}′=R⁻¹J′R (51)
At the center of the field of view (43), the Jacobians J′ and \tilde{J}′ are the identity matrices and the resolutions Δx′, Δy′, Δz′.
3.3 Additional Parameters

The parameter κ is defined by

$$κ = \frac{{\vert B \vert}_{{max}_{P}}}{{\vert B \vert}_{{max}_{F ⋂ D ⋂ P}}} \geq 1 \qquad ( 52 )$$

where B|_{max P} and B|_{max F∩D∩P} indicate the maximum values of B attained over a region P , such as a patient, and over the intersection F∩D∩P , where F is the field of view and D is the region of sensitivity of the detection coil. A second parameter κ_{D} is defined by

$${k}_{D} = \frac{{\vert B \vert}_{{max}_{D ⋂ P}}}{{\vert B \vert}_{{max}_{F ⋂ D ⋂ P}}} ∈ [ 1 , k ] \qquad ( 53 )$$

4 MRI Using First and Second Embodiments

Field Coordinate with (14)

The current densities of the first and second embodiments are (5) and (20). Under conditions (9) and (16) with (14), the field is (17) and field coordinate

$$\begin{matrix}\tilde{z} = \frac{B}{{G}_{z}} & ( 54 a ) \\ \approx ( {y}_{0} + {y}_{c} ) {Tan}^{1} \frac{z}{y + {y}_{c}} & ( 54 b )\end{matrix}$$

Within a field of view F that is a rectangular box Lₓ×L_{y}×\tilde{L}_{z} in coordinates (x, y, \tilde{z}) centered about x₀, y₀, 0) , (9) is satisfied given (11) and (12), and (16) is satisfied given

$${\vert z \vert}_{maxF} = ( \frac{{L}_{y}}{2} + {y}_{0} + {y}_{c} ) tan \frac{{L}_{z}}{2 ( {y}_{0} + {y}_{c} )} << {l}_{ z} / 2 , R \qquad ( 55 a )$$

and
\tilde{L}_{z}≦π(y₀+y_{c}) (55b)
The field coordinate \tilde{z} (54) then satisfies (28).
4.2 Improved Fields

The ideal LC_{z} field
B^{id}(\vec{r}, t)=G_{z}\tilde{z}^{id}(z; \tilde{L}_{z}) (56)
where the field coordinate

$${\tilde{z}}^{id} ( z ; {\tilde{L}}_{z} ) = \{ \begin{matrix}{\tilde{L}}_{z} / 2 , & z > {\tilde{L}}_{z} / 2 \\ z , & z ∈ [ - {\tilde{L}}_{z} / 2 , {\tilde{L}}_{z} / 2 ] \\ - {\tilde{L}}_{z} / 2 , & z < - {\tilde{L}}_{z} / 2\end{matrix} \qquad ( 57 )$$

For a field of view with \tilde{z}^{id}∈[−\tilde{L}_{z}/2\tilde{L}_{z}/2], the field B^{id} has the values κ=κ_{D}=1 and a uniform resolution Δz(θ\tilde{z}/θz)⁻¹ (36) along z for z∈[−\tilde{L}_{z}/2, \tilde{L}_{z}/2].

Curent density profiles J(z) that produce fields B better approximating the ideal fields B^{id} (56) over D than (17) can be calculated. The field B(x₀, y₀, z) is given by (7), where g(x₀, y₀, z) is (8) for the first embodiment and (22) for the second embodiment. The integral (7) can be approximated by a sum:

$${B}_{i} \approx δ z {\sum }_{j = - n}^{n} {g}_{i - j} {J}_{j} \qquad ( 58 )$$

where
Bⱼ=B(x₀, y₀, jδz) (59a)
Jⱼ=J(jδz) (59b)
gⱼ=g(x₀, y₀, jδz) (59c)
and J(z) either vanishes or is neglected for |z|≧nδz

Defining the matrix
Gᵢⱼ=δzg₁₋ⱼ (60)
and treating Bⱼ and Jⱼ as column vectors, the approximation (58) becomes the matrix equation

$${B}_{i} \approx {\sum }_{j = - n}^{n} {G}_{ij} {J}_{j} \qquad ( 61 )$$

For the first embodiment

$${G}_{ij} {=}_{( 8 )} \frac{{μ}_{0} Y δ z}{4 π} {\int }_{- {l}_{x} / 2}^{{l}_{x} / 2} ⅆ {x}^{′} \frac{1}{{[ {X}^{2} + {Y}^{2} + {( δ z )}^{2} {( i - j )}^{2} ]}^{3 / 2}} + \frac{{μ}_{0} R δ z}{4 π} {\int }_{{I}_{φ}}^{} ⅆ {φ}^{′} \frac{R - {r}_{0} cos Φ}{{[ {R}^{2} + {r}_{0}^{2} - 2 {Rr}_{0} cos Φ + {( δ z )}^{2} {( i - j )}^{2} ]}^{3 / 2}} \qquad ( 62 )$$

where

$$\begin{matrix}X = {x}_{0} = {x}^{′} & ( 63 a ) \\ Y = {y}_{0} + {y}_{c} & ( 63 b ) \\ Φ = {φ}_{0} - {φ}^{′} & ( 63 c ) \\ {r}_{0} = \sqrt{{x}_{0}^{2} + {y}_{0}^{2}} & ( 63 d ) \\ {φ}_{0} = {cos}^{- 1} \frac{{x}_{0}}{{r}_{0}} = {sin}^{- 1} \frac{{y}_{0}}{{r}_{0}} & ( 63 e )\end{matrix}$$

Both terms are decreasing functions of i−j . In addition, the first term is positive for y₀≦−y_{c} and the second term is positive for r₀≦R , using

$$\begin{matrix}0 < R - {r}_{0} \leq R - {r}_{0} cos ( φ - {φ}^{′} ) & ( 64 a ) \\ and & \\ 0 < {( R - {r}_{0} )}^{2} = {R}^{2} + {r}_{0}^{2} - 2 R {r}_{0} & ( 64 b ) \\ \leq {R}^{2} + {r}_{0}^{2} - 2 R {r}_{0} cos ( φ - {φ}^{′} ) & \end{matrix}$$

Therefore, Gᵢⱼ is a positive, decreasing function of i−j for y₀≦−y_{c} and r₀≦R , and the determinant

$$det G = {\sum }_{σ ∈ {S}_{2 n + 1}}^{} ( sgn σ ) {G}_{- n , {σ}_{- n}} … {G}_{n , {σ}_{n}} \qquad ( 65 )$$

can be written as an alternating sum of decreasing terms. Consequently, det G≠0 and the inverse matrix (G⁻¹)ⱼᵢ exists.

For the second embodiment

$${G}_{ij} {\approx }_{( 23 )} \frac{{μ}_{0} Y δ z}{2 π [ {Y}^{2} + {( δ z )}^{2} {( i - j )}^{2} ]} - \frac{{μ}_{0} {R}^{2} δ z}{4 {π [ {R}^{2} + {( δ z )}^{2} {( i - j )}^{2} ]}^{3 / 2}} [ ( 1 - 2 {ɛ}_{φ} ) π + ( \frac{3 {R}^{2}}{{R}^{2} + {( δ z )}^{2} {( i - j )}^{2}} - 1 ) \frac{{l}_{x} {r}_{0} {y}_{0}}{{R}^{3}} ] \qquad ( 66 )$$

under conditions (9) on (x, y)=(x₀, y₀) and using (63). Defining

$$W = ( 1 - 2 {ɛ}_{φ} ) π + \frac{2 {l}_{x} {r}_{0}}{{R}^{3}} min \{ {y}_{0} , 0 \} \qquad ( 67 )$$

Gᵢⱼ is a positive, decreasing function of i−j for
0≦Y≦≦R (68)
and

$$n δ z < \sqrt{\frac{{RW}_{yo}}{2}} \qquad ( 69 )$$

and the determinant det G (65) can be written as an alternating sum of decreasing terms. Consequently, det G≠0 and the inverse matrix (G⁻¹)ⱼᵢ exists.

Using the inverse matrix (G⁻¹)ⱼᵢ, the equation

$${J}_{j} \approx {\sum }_{i = - n}^{n} {( {G}^{- 1} )}_{ji} {B}_{i} \qquad ( 70 )$$

can be used to find Jⱼ required to produce specified field values Bᵢ .

Let D be such that
D∈{(x, y, z): |z|≦nδz} (71)
and let \tilde{b}(z) be a smooth function better approximating the ideal field B^{id} over D∩λthan (17), where λis the line
λ={(x, y, z): x=x₀, y=y₀} (72)
With
Bᵢ=\tilde{b}(iδz) (73)
values of \tilde{b}(z) Jⱼ can be calculated from (70) and a current density profile J(z) constructed by connect-the-dots. The smooth field B(x, y, z) (7) produced by J(z) better approximates B^{id} over D than (17).
4.3 Adjustable Field of View

The first and second embodiments can be designed with several fields of view
η₁\tilde{L}_{z}≦η₂\tilde{L}_{z}≦ . . . ≦η_{N}\tilde{L}_{z} (74)
in mind. Let fields G_{z}\tilde{z}ₐ, a=1, . . . , N , approximate ideal fields (57) over D :
\tilde{z}ₐ|D≈\tilde{z}^{id}(z; ηₐ\tilde{L}_{z})|D (75)
The notation D means restricted to D . Define fields Bₐ by
B₁=G_{z}\tilde{z}ₐ₌₁ (76a) and, for a=2, . . . , N ,
BₐG_{z}(\tilde{z}ₐ\tilde{z}ₐ₋₁) (76b)
Current density profiles Jₐ(z) producing fields approximating Bₐ can be found by the method of Sec. (4.2). With components a=1, . . . , N carrying Jₐ(z) , the first k≦N components generate a field
B^{(k)}=B₁+ . . . +Bₖ=G_{z}\tilde{z}ₖ (77a)
with
B^{(k)}|D≈\tilde{z}^{id}(z; ηₖ\tilde{L}_{z})|D (77b)
5 Advantage of LC Coil for MRI

The gradient of an LC coil with smaller fields outside the field of view can be switched more rapidly without violating a bound on the field rate of change. Consequently, larger regions of k -space can be covered within a given time.

It is to be understood that while the invention has been described in conjunction with the detailed description thereof, the foregoing description is intended to illustrate and not limit the scope of the invention, which is defined the scope of the appended claims. Other aspects, advantages, and modifications are within the scope of the following claims.

1. An apparatus comprising:
a current-carrying element with a first region carrying a first current;
a second region adjacent to said first region;
said second region carrying a second current;
said second current differing from said first current where adjacent; and
a magnetic resonance imaging machine.

2. Said apparatus of claim 1 wherein:
said second region separated from said first region by a planar interface; and
said first and second regions being mirror images in said planar interface.

3. Said apparatus of claim 1 wherein:
said first current has a first direction;
said second current has a second direction; and
said second direction is opposite said first direction.

4. Said apparatus of claim 2 wherein opposite of said second current being a mirror image of said first current in said planar interface.

5. Said apparatus of claim 4 wherein:
said first region carries a first volume current density;
said first region has a first thickness;
said first region carries a first current density, comprising said first volume current density integrated over said first thickness of said first region; and
said first current density is constant over said first region.

6. Said apparatus of claim 1 comprising a support surface.

7. Said apparatus of claim 6 wherein said first and second regions pass under and conform to said support surface.

8. Said apparatus of claim 7 wherein said support surface is flat.

9. Said apparatus of claim 8 wherein said current-carrying element has cross-section comprising an arc of a circle.
